(19) United States
(12) Patent Application Publication
(10) Pub. No.: US 2025/0056502 A1
(43) Pub. Date: Feb. 13, 2025

(54) Spectrum Reuse Framework in O-Ran Architecture

(71) Applicant: Celona, Inc., Campbell, CA (US)

(72) Inventors: Vanlin Sathya, Campbell, CA (US); Manan Shaw, Campbell, CA (US); Aasawaree Deshmukh, Campbell, CA (US); Mehmet Yavuz, Campbell, CA (US)

(21) Appl. No.: 18/448,060

(22) Filed: Aug. 10, 2023

(51) Int. Cl. H04W 72/04

(52) U.S. Cl. CPC H04W 72/04; H04W 88/08

(57) ABSTRACT

A method and apparatus are disclosed that determine the allocation of resources within a communication network. In particular, the presently disclosed method and apparatus ensures an efficient allocation of resources, such as resource blocks and the setting of power levels. Various regions are defined based on the quality of signals received by UEs (user equipment).

### BACKGROUND

### (1) Technical Field

The disclosed method and apparatus relate generally to systems for Open Radio Access Network (O-RAN) architecture and more particularly, the disclosed method and apparatus relates to efficient allocation of spectrum in an O-RAN architecture.

### (2) Background

Frequency spectrum that can be used to allow wireless communication with a mobile device, such as a cell phone, IoT (Internet of Things) device, laptop computer, robot, manufacturing equipment, etc., is a very valuable commodity. In order to allow more wireless device users to connect to wireless communications networks, the US Federal Government recently finalized rules for the use of an area of the frequency spectrum referred to as the CBRS (Citizens Broadband Radio Service). CBRS operates in a 150 MHz wide frequency range from 3.55 GHz to 3.7 GHz. Access to the spectrum is provided in three distinct tiers: (1) Incumbent users; (2) Priority Access License (PAL) users; and (3) General Authorized Access (GAA) users. Incumbent users are the highest tier and include military radar systems, satellite ground stations and wireless ISPs. These incumbent users are protected from possible interference from the other two lower tier users at all times.

PAL users are the next highest tier and have priority over and are protected from interference by GAA users. PAL licenses are assigned based on spectrum auctions. Each PAL license covers one 10 MHz channel for a single census tract for a predefined term. Census tracts are geographical areas defined on the basis of population statistics. The area boundaries of the census tracts are not expected to change much over time. For any given census tract, up to seven total PAL licenses may be assigned (i.e., seven 10 MHz channels per census tract, comprising 70 MHz within the 150 MHz CBRS band). There are over 70,000 such census tracts in the US. In some cases, a PAL frequency range may change over the course of the license based on activity by incumbent users.

GAA users are licensed-by-rule to permit open, flexible access to the band for a wide group of potential users. GAA users are guaranteed access to a minimum of 80 MHz and are permitted to use any portion of the 3.5 GHz band not assigned to a higher tier user. GAA users may also operate opportunistically on unused Priority Access channels.

The use of CBRS band, and in particular use by GAA users, raises the potential for interference between users of adjacent GAA channels. More particularly, in some cases a CBRS network may be established within a subspace of a larger public network.

Due to restrictions on the use and availability of GAA channels, it is important to be able to manage the spectrum efficiently and flexibly, so that the higher priority users can gain access to the spectrum as requirement, while still allowing the GAA users to communicate in a manner that satisfies their needs.

Accordingly, it would be advantageous to provide a method and apparatus to be used in a communication system that provides agile and efficient allocation of frequency spectrum.

### SUMMARY

Various embodiments of a method and apparatus are disclosed for determining the allocation of resources within a communication network. In particular, the presently disclosed method and apparatus ensures an efficient allocation of resources, such as resource blocks and the setting of power levels. Various regions are defined based on the quality of signals received by UEs (user equipment). In one embodiment in which the network is an outdoor network, three such regions are defined; a outer region furthest from an AP (Access Point), a mid-cell region (just inside the outer region) and a near-cell region closest to the AP. Each region is provided a different range of resource, i.e., RBs (source blocks) that my be allocated for communication with those UEs in that region. Control of the allocation of resources is adjusted by various components of the network (i.e., RICs (Radio Access Network Intelligent Controller)) that reside either near the edge (i.e., close to an AP), at a higher level within the network, such as near a PCP Unit (Power Control Policy for Cell Center and Edge Region) or an IMRA Unit (Interference Management and Resource Allocation), allowing these higher level components to coordinate the control of the resource allocation across various APs connected to different BBUs (Baseband Units).

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of one deployment strategy in accordance with some embodiments of the disclosed method and apparatus.

FIG. 2 is an illustration of a time/frequency matrix for allocation of spectrum for one particular area serviced by one particular BBU.

FIG. 3 is a flowchart showing one embodiment for determining the allocation of RBs to particular communication links to UEs when the regions are essentially static and the APs are operating in-doors.

FIG. 4 is a flowchart of the method performed when the regions are dynamic and the APs are operating in-doors.

FIG. 5 is a flowchart of the method performed when the APs are operating out-doors with static definitions of the regions.

FIG. 6 illustrates the call flow for messages between APs connected to the same BBU, the BBU to which the APs are connected and a SON.

FIG. 7 illustrates the call flow for messages between APs, a BBU that is not common to the APs, the near RIC and edge RIC and the SON in the situation in which there is interference between APs that are not connected to a common BBU.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

The disclosed method and apparatus provides a method and apparatus by which spectrum can be managed and messaging regarding the manner in which spectrum is to be allocated can be flexibly established depending upon interference between various entities that might be physically close and transmitting on frequencies that are likely to cause interference with one another. Frequency allocations can be made by a logical device operating at one of three different physical locations within the network. By having the flexibility to determine where decisions regarding the allocation of spectrum are made, tradeoffs can be made between reducing latency in the messaging between the device allocating the frequency spectrum and device that will be implementing the frequency allocation (i.e., the baseband unit within the network that will be transmitting signal wirelessly over the downlink and receiving signals wirelessly over the uplink).

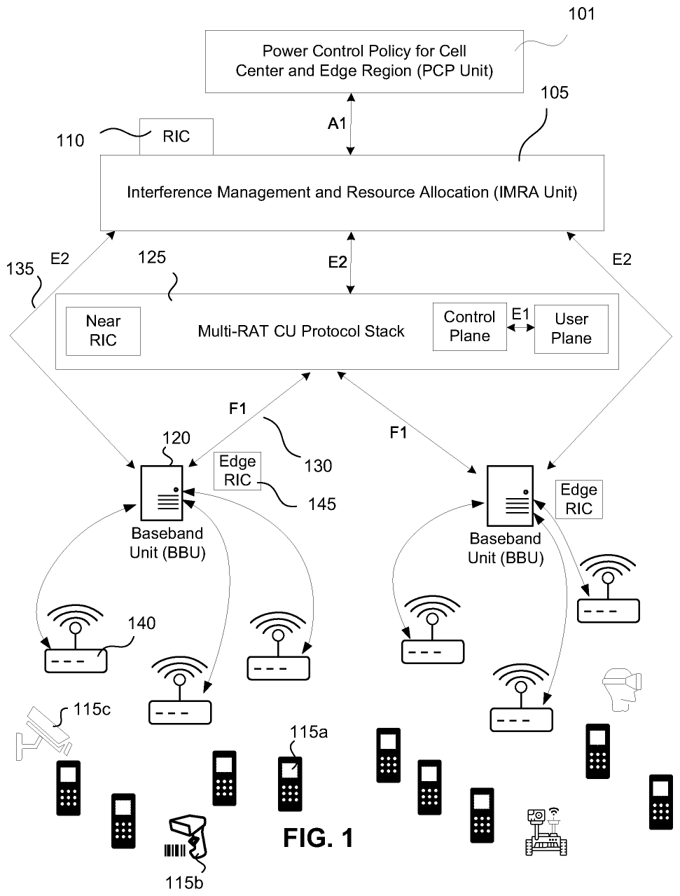

FIG. 1 is an illustration of one deployment strategy in accordance with some embodiments of the disclosed method and apparatus. A first logical unit referred to for the sake of this disclosure as a PCP (Power Control Policy) Unit 101, sets power control policy at the Cell Center and Outer Region. The PCP Unit 101 is essentially a computer running a software application that establishes the control policy at a network global level. The PCP Unit 101 interfaces with another computer, referred to for the sake of this disclosure as a IMRA (Interference Management and Resource Allocation) Unit 105, running a software application that provides interference management and resource allocation functionality. The interface between the PCP Unit 101 and the IMRA Unit 105 operates in accordance with an industry standard A1 protocol.

A RIC (RAN Intelligent Controller) 110 is essentially another logical functional unit (i.e., a software program running on a computer) that provides non-real time (i.e., greater than 1 sec latency) control over service and policy management and RAN analytics, etc. In some embodiments, the RIC 110 is co-located with the IMRA Unit 105 and in some embodiments is executed using the same processor as is used to execute the IMRA Unit functionality. In other embodiments, the RIC 110 is close by, but not co-located with the IMRA Unit 105. The control over service and policy management includes determining when, and at what frequency, to send RBs (resource blocks). An RB is the smallest packet of data that can be transmitted through the communication network. For each physical area over which the network operates to communicate wirelessly with UEs 115, there is a matrix of time/frequency slots for transmitting RB associated with the physical area through which the communication will occur. Therefore, there may be several areas within the network, each having a BBU (baseband unit) 120. In some embodiments, each BBU 120 is connected to an MRAT (Multi-Radio Access Transport Control Unit Protocol Stack) 125 via an industry standard F1 protocol link 130. In some embodiment, BBUs 120 are also connected to the IMRA Unit 101 over an industry standard E2 protocol link 135.

The network communicates wirelessly with the UEs 115 through APs (Access Points) 140 that are in the neighborhood of one of the BBUs 120. In some embodiments, the APs 140 are hardwired to one of the BBUs 120.

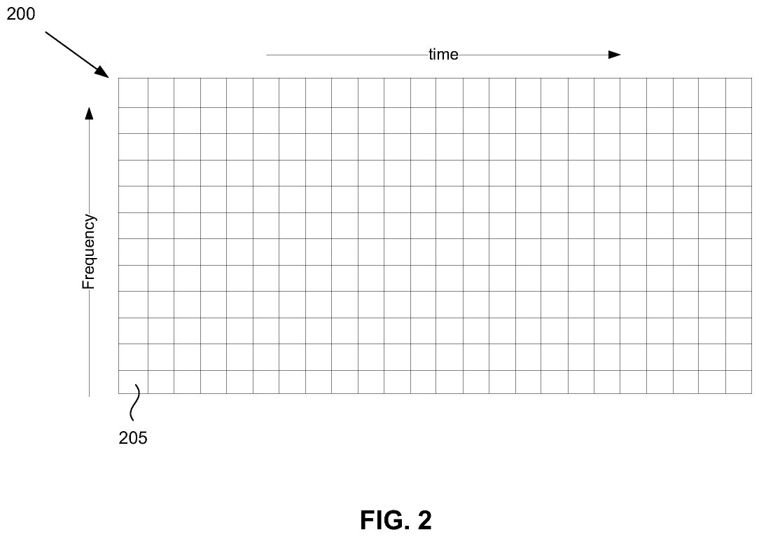

FIG. 2 is an illustration of a time/frequency matrix 200 for allocation of spectrum for one particular area serviced by one particular BBU 120. Each time/frequency slot 205 represents and time and frequency at which an RB is to be transmitted. By allocating each time/frequency slot to the uplink and downlink between an AP 140 and a UE 115, interference between signals that are being transmitted in the same geographic area is avoided.

In some embodiments, UEs 115 can be identified as being in one of several “regions”. For portions of the network operating outdoors, such regions are designated as a “near-cell”, “mid-cell” or “outer” region. UEs 115 in the near-cell region will receive high performance wireless link to the AP 140 servicing that UE 115. Due to the high quality of the wireless link between a UE 115 in the near-cell region and the AP 140 servicing that UE 115, a smaller number of RBs are allocated to the communication link to this UE 115 by a MAC (Media Access Control) scheduler. That is, the number of RBs allocated is less than α₁, where α₁ is a particular value representing a maximum number of RBs allocated to a UE 115 that is in the near-cell region. Because of the high quality wireless link, the amount of data that can be communicated in one RB is greater, thus fewer RBs are required to transmit the same amount of data as would be required if the wireless link were of a lesser quality (i.e., weaker signal, more potential interference, etc.) That is due to the ability of the network to use a denser modulation scheme (i.e., a high modulation coding scheme) to modulate the signal being transmitted in any one time/frequency slot of the communication link between the AP 140 and the UE 115 when the UE 115 is in a near-cell region. In some embodiments, parameters, such as: (1) RSRP (Radio Signal Receive Power), number of PCI visible in the near cell based on a measurement report, CQI/SINR (Channel Quality Indicator/Signal to Interference plus Noise Ratio) feedback, RSSI (Receive Signal Strength Indicator) are used to define the region. Accordingly, each region has a different range of resources that can be allocated to that region.

UEs 115 in the mid-cell region will experience high performance with a medium number of RBs being allocated, compared to UEs 115 in near and outer-cell regions. The number of RBs allocated to the link between an AP 140 and a UE 115 in the mid-cell region is equal to, or greater than, α₁ and less than or equal to α₂, where α₂ is a second value indicating a number of RBs) as determined by the MAC scheduler. The other parameters such as RSRP, number of PCI visible in the mid cell based on measurement report, CQI/SINR feedback, RSSI are used to define the region.

UEs in the outer-cell experience a lower level of performance compared to near-cell, but are provided with a greater number of RBs (i.e., the number of RBs is greater than α₂) as provided by the MAC scheduler, compared to near-cell. The other parameters such as RSRP, number of PCI visible in the outer cell based on measurement report, CQI/SINR feedback, RSS are used to categorize the region more reliably.

In addition to the UEs 115 that reside in these three geographic areas, a UE 115 may be a handover candidate, meaning that it currently being serviced by a first AP, but is close to a second AP 140 and might benefit by switching to communicate through the second AP 140. In some cases, this type of user will not be transmitting many RBs, but the PCI will vary over time. The other parameters, such as association time per AP, RRC_Connected and RRC_Disconnected state may be used to characterize the UE 115 as being a handover candidate.

In some embodiments, portions of a network in which the APs 140 are indoors have only two regions; close-cell and outer region.

In both indoor and outdoor settings, the regions may be either relatively static or relatively dynamic. That is, if the UEs 115 are moving around, they may move from one region to another (i.e., from mid-cell to outer). In addition, the information regarding the boundaries of the regions can be more dynamic, since the UEs 115 can provide feedback to the network regarding the quality of the signal it is receiving from several APs 140, including the AP that is current servicing that UE 115.

Defining these different regions allows more efficient and effective decisions to be made regarding the allocation of RBs to the communication link between a particular AP 140 and each of the UEs 115 that are being serviced by the AP 140.

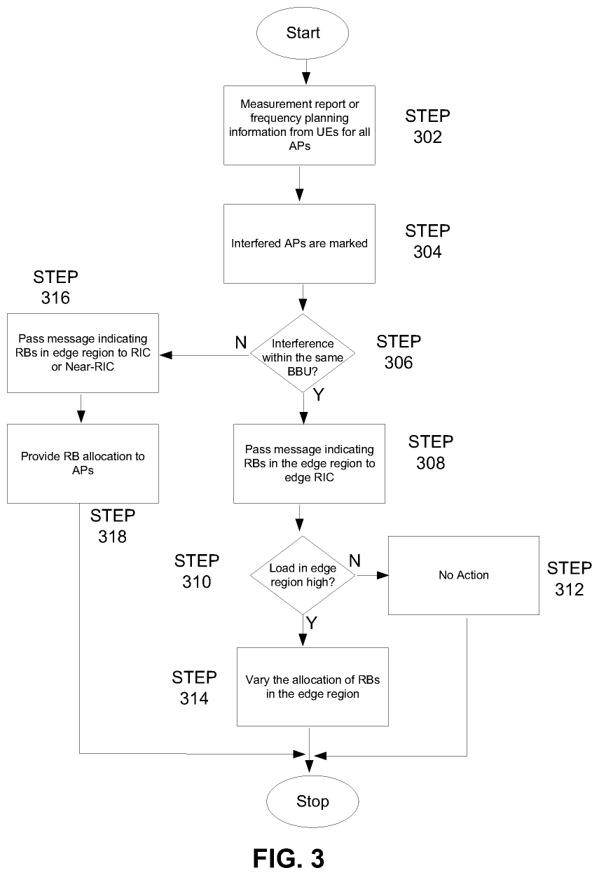

FIG. 3 is a flowchart showing one embodiment for determining the allocation of RBs to particular communication links to UEs 115 when the regions are essentially static (i.e., most UEs 115 are not moving around) and the APs are operating in-doors. Initially, information about the signal quality in the links between the UEs 115 and the APs 140 is determined from either measurement reports provided by the UEs 115 or from frequency planning information, or both (STEP 302). Next, those APs 140 determined to have interference in the link between the AP 140 and at least one UE 115 are identified from the information gather in STEP 302 (STEP 304). Next, a determination is made as to whether the interference is between APs 140 connected to the same BBU 120 (STEP 306). If so, a message is passed to an edge RIC 145 that is in close proximity to the BBU 120 to which the APs 140 that see the interference are connected (STEP 308). The edge RIC 145 can then determine whether the loading in the outer region is high (STEP 310). If not, then no action is taken (STEP 312). However, if the loading at the outer region is high, then the number of RBs is adjusted (STEP 314). Returning to STEP 306, if the interference is not between APs 140 connected to the same BBU 120, then a message is passed to the RIC 110 or a Near RIC 150 that resides in relatively close proximity to the MRAT 125 (STEP 316). In this way, coordination between the allocation of RBs to the APs 140 that are connected to different BBUs 120 can be handled (STEP 318).

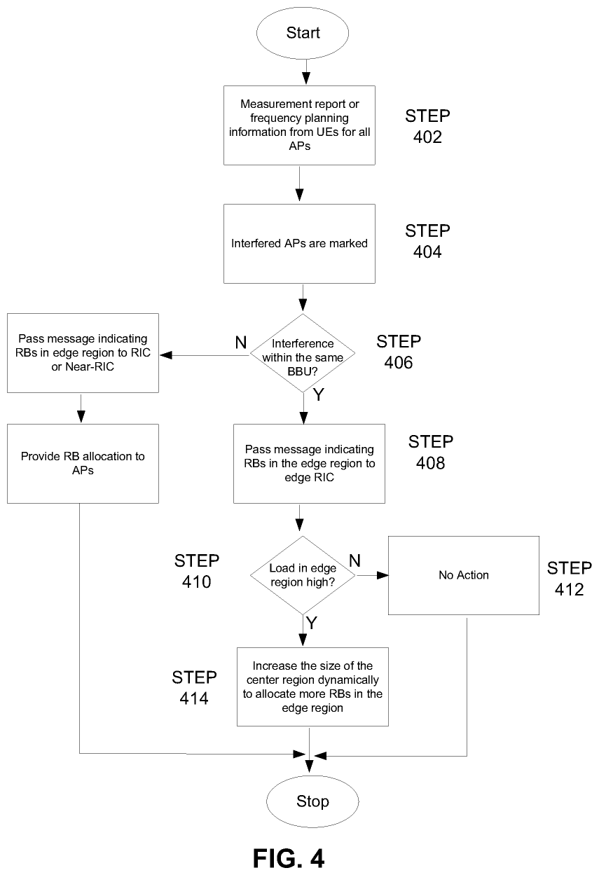

FIG. 4 is a flowchart of the method performed when the regions are dynamic (i.e., there are several UEs 115 that move around within the network) and the APs 140 are operating in-doors. The method shown in FIG. 4 is essentially the same as the method of FIG. 3, except that in STEP 410 if the load in the outer region is high, then the size of the center region is increased. This then reduces the number of UEs 115 in the outer region, allowing more RBs to be allocated to the UEs 115 in the outer region (STEP 414). That is, the parameter used to determine whether a UE 115 is in the outer region or the mid-cell region is varied to put more UEs 115 in the mid-cell, thus leaving more RBs to be allocated to each UE 115 that remains in the outer region.

In some embodiments, information regarding the movement of UEs 115 into and out of various regions, as well as information regarding the adjustments being made to the size of the regions is used to determine whether the system is performing in an unstable manner. If it is determined that the system is tending toward instability, the process of changing the parameters that are bringing the system to that point is slowed to increase the likelihood of the system remaining stable and reducing the potential for instability.

In some embodiments, in addition to adjusting the allocation of RBs, the power levels at which APs 140 transmit can be adjusted to reduce interference.

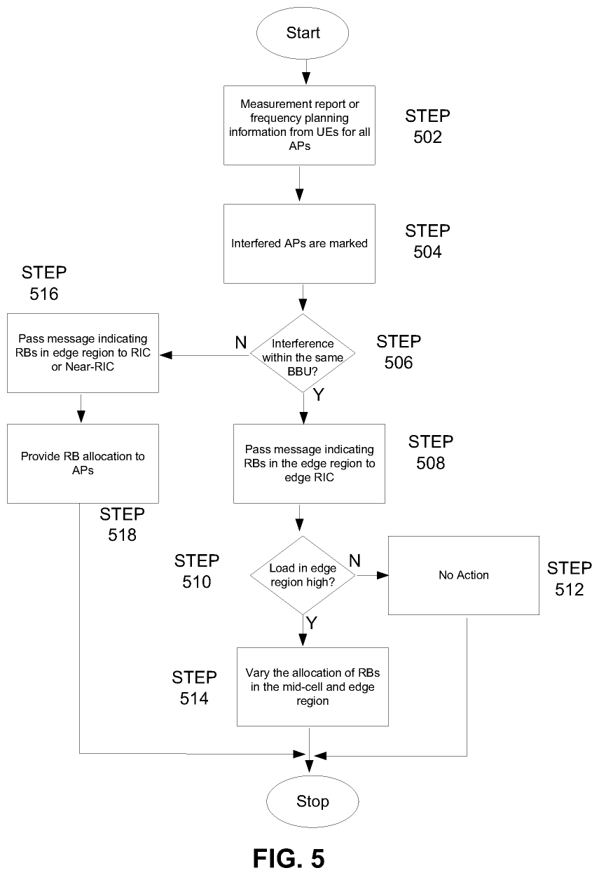

FIG. 5 is a flowchart of the method performed when the APs 140 are operating out-doors with static definitions of the regions. In some embodiments, when the APs are operating out-doors, the regions remain static and do not flex with the loading, since the size of the regions out-doors is typically larger and the desire to alter the definitions of the regions is less advantageous. Nonetheless, in some embodiments, the same procedure for dynamically altering the definition of regions can be performed in out-door settings as well.

The method shown in FIG. 5 is essentially the same as that shown in FIG. 3. However, in STEP 516, messages are passed to the RIC 110 and/or near RIC 150. Next, an RB allocation is provided to the APs in response to the messages sent to the RIC 110 and/or the near RIC 145 (STEP 518).

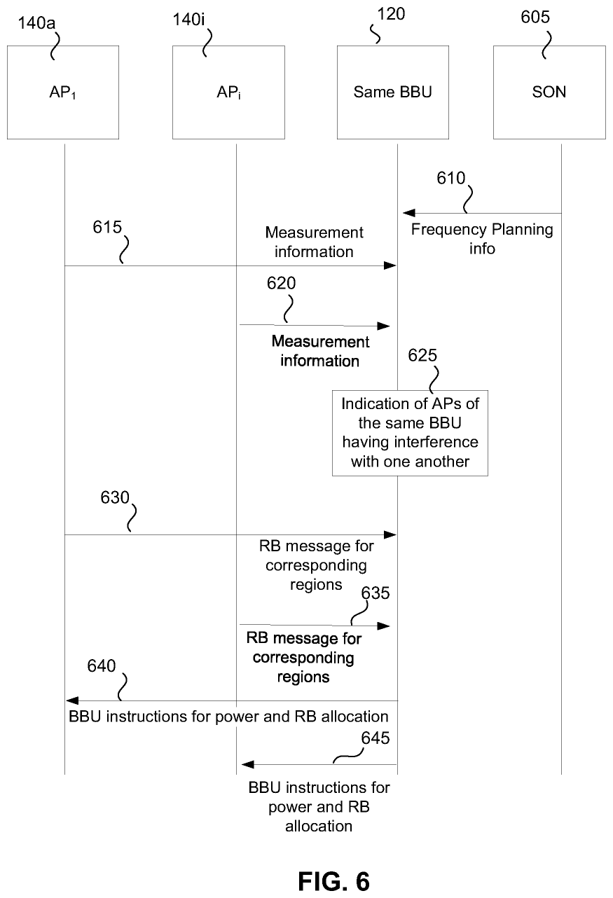

FIG. 6 illustrates the call flow for messages between APs 140 connected to the same BBU 120, the BBU 120 to which the APs 140 are connected and a SON (Self Organizing Network device) 605.

Initially, the SON 605 provides a frequency plan 610 to the BBU 120 that indicates what frequencies are to be used in composing the frequency/time matrix 200 to be used by the BBU 120. Next, the APs 140 provide measurement reports 615, 620 to the BBU 120. In response to the information provided in the measurement reports, a functional block 625 is performed by the BBU 120 to note which of the APs 140 have an issue with interference between with another AP 140 connected to the same BBU 120. In some embodiments, the fact that two APs 140 are using the same time/frequency slot is sufficient to cause the APs 140 to be flagged. Next, each of the APs 140 provide messages 630, 635 to the BBU 120 indicating the RB allocations for their activities. It should be noted that the means by which the RBs are initially allocated by the APs 140 is relatively conventional. However, that allocation is then adjusted by the BBU providing instructions 640, 645 to the APs 140 regarding power and RB allocations that reduce the potential for interference by reducing the number of time/frequency slots that are common to APs 140 that might otherwise interfere with one another.

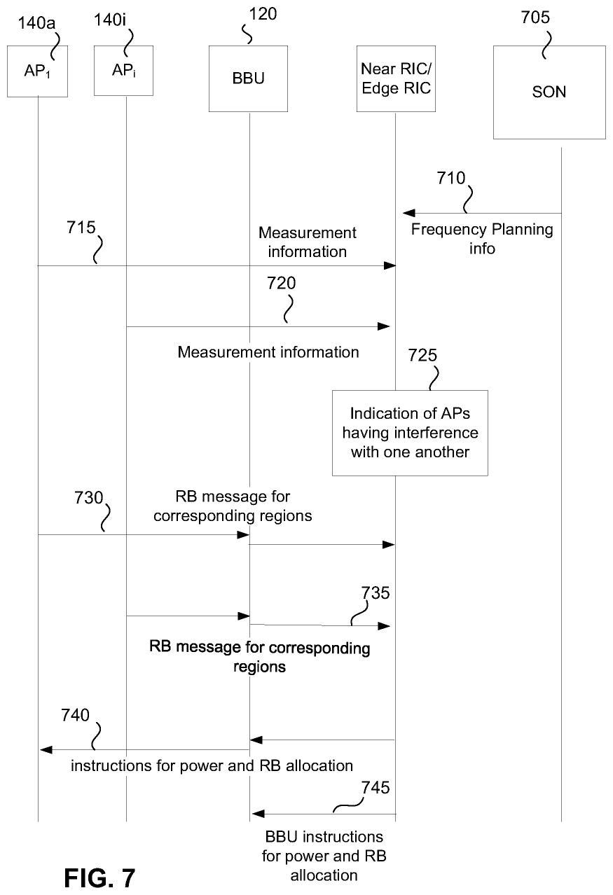

FIG. 7 illustrates the call flow for messages between APs 140, a BBU 120 that is not common to the APs 140, the near RIC 150 and edge RIC 145 and the SON 705 in the situation in which there is interference between APs 140 that are not connected to a common BBU 120. The SON 705 provides the frequency plan to the near RIC 150 and the edge RIC 145. In this case, each of the APs 140 sends a measurement report 715, 720 to either the edge RIC 145 or to the near RIC 150 or both. The edge RIC 145 and/or the near RIC 150 perform a functional block 725 in which they indicate which APs have an interference issue. Each AP 140 then sends a message 730, 735 indicating the RB allocations to be used by that AP 140. In response, the edge RIC 145 and/or the near RIC 150 provide instructions 740, 745 for allocation of power and RBs.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one.” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for allocation of resources in a communication network comprising:
establishing three regions, the first of the three regions defined as an outer region furthest from an AP (Access Point), the third of the three regions being defined as a near-cell region closest to the AP and the second of the three regions being defined as a mid-cell region between the outer region and the inner region; and
allocating resources to at least one of the regions;
wherein each region is provided a different range for the allocation of the resources.

2. The method of claim 1, wherein RBs (source blocks) are the resource that are allocated for communication with those UEs in the region to which the resource is to be allocated.

3. The method of claim 1, wherein control of the allocation of resources is adjusted by a RICs (Radio Access Network Intelligent Controller) that resides close to an AP.
